(19) United States
(12) Patent Application Publication
(10) Pub. No.: US 2022/0274274 A1
(43) Pub. Date: Sep. 1, 2022

(54) NON-METALLIC RAZOR BLADES AND RAZOR ASSEMBLIES THEREFOR

(71) Applicant: ANCHOR MANUFACTURING GROUP, INC., Cleveland, OH (US)

(72) Inventor: Jeffrey A. Percival, Montreal, MO (US)

(21) Appl. No.: 17/627,242

(22) PCT Filed: Jul. 16, 2020
(86) PCT No.: PCT/US2020/042230

§ 371 Date: Jan. 14, 2022

Related U.S. Application Data
(60) Provisional application No. 62/875,273, filed on Jul. 17, 2019.
(60) Provisional application No. 62/875,275, filed on Jul. 17, 2019.
(60) Provisional application No. 62/875,280, filed on Jul. 17, 2019.
(60) Provisional application No. 62/875,282, filed on Jul. 17, 2019.

(51) Int. Cl. B26B 21/60; B26B 21/40

(52) U.S. Cl. CPC B26B 21/60; B26B 21/4012; B26B 21/4068

(57) ABSTRACT

Non-metallic razor blades, such as those made with ceramic or glass, and more particularly to one or more unique features of such blades that improve the durability and useable life of the blade. The non-metallic blade may have a single-bevel design with a unique geometry. The blade may be made with a chemically strengthened glass. The blade may be made with single-crystal alpha-alumina in which the razor edge is oriented perpendicular to the c-axis. A razor assembly also is provided such as for use with non-metallic blades. The mounting head of the assembly is configured to restrict rotation of the blade about a pivot axis that is parallel to the blade edge. The mounting head also is configured to enable the blade to move axially in a direction perpendicular to the blade edge. The mounting head may orient the blades to enable passage of shaved hair.

### RELATED APPLICATIONS

This application claims the benefit of U.S. Provisional Application No. 62/875,275 filed Jul. 17, 2019, U.S. Provisional Application No. 62/875,280 filed Jul. 17, 2019, U.S. Provisional Application No. 62/875,282 filed Jul. 17, 2019, and U.S. Provisional Application No. 62/875,273 filed Jul. 17, 2019, all of which are hereby incorporated herein by reference in their entireties.

### TECHNICAL FIELD

The present disclosure relates generally to razor blades, more particularly to non-metallic razor blades, and to razor assemblies such as for use with non-metallic razor blades.

### BACKGROUND

Conventional shaving razor blades commonly are made of stainless steel ribbons, which may be hard coated with other materials to improve their durability and useable life. These conventional razor blades usually are mounted in a disposable cartridge or other razor blade holder for shaving hair.

### SUMMARY

A problem with conventional stainless steel razor blades is that they are relatively ductile and prone to damage and wear. For example, the razor edge of a stainless steel blade may become dull due to gradual abrasive wear from cutting hair (i.e., shaving), whereby the razor edge becomes more rounded or nicked after repeated shaves. In addition, although such stainless steel blades are resistant to corrosion, there still may be some corrosive effect at the microscopic blade edge that affects the perceived comfort of the shave.

According to an aspect, the present disclosure provides a non-metallic razor blade made with ceramic or glass that includes one or more unique aspects that improve the durability and useable life of the blade.

For example, one aspect of the present disclosure provides a razor blade formed of ceramic or glass that includes a single-bevel design having a unique geometry of the bevel angle and/or the blade tip for mitigating breakage or other damage, thereby enhancing the life of the blade.

According to an aspect of the present disclosure, a non-metallic razor blade includes: a substrate made with a non-metallic material; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion: terminating at a razor edge extending along a width of the substrate; formed between the beveled surface and the first substrate surface; including a major surface (1) proximal the razor edge and (2) being at least partially disposed in a tip plane that diverges from the beveled plane towards the first substrate surface; wherein a first included angle between the first substrate plane and the beveled plane is in a range from 18 degrees to 30 degrees; and wherein a second included angle between the first substrate plane and the tip plane is in a range from 20 degrees to 70 degrees.

Another aspect of the present disclosure provides for different blade geometries depending on the whether the intended use of the design is for a male or female. This is because females traditionally use razor blades to shave their legs or armpit hair, which typically is less coarse than male facial hair, and these areas typically are less sensitive than for male facial hair.

According to an aspect of the present disclosure, a male non-metallic razor blade includes a first included angle between a first substrate plane and a beveled plane that is in a range from 18 degrees to 25 degrees; and a female non-metallic razor blade includes a first included angle in a range from 25 degrees to 30 degrees.

Another aspect of the present disclosure provides a razor blade made with a chemically-strengthened glass that is configured to improve strength and resist breakage of the blade, particularly at the razor edge.

According to an aspect of the present disclosure, a razor blade includes: a chemically-strengthened glass substrate having a razor edge.

According to another aspect of the disclosure, a razor blade includes: a substrate made with a chemically-strengthened glass; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion (1) terminating at a razor edge extending along a width of the substrate and (2) formed between the beveled surface and the first substrate surface.

According to another aspect of the disclosure, a method of manufacturing a razor blade includes: providing a glass substrate prior to chemical strengthening; sharpening the glass substrate to provide a razor edge; and performing chemical strengthening of the sharpened substrate.

In exemplary embodiments, the chemical strengthening comprises performing ion exchange strengthening of an outer surface of the sharpened substrate to increase a strength of a region of the sharpened substrate. The ion exchange treatment forms a layer of compression at an outer surface region of the glass. This region of compression includes at least the razor edge portion of the glass razor blade, which improves strength and resists breakage of the blade, particularly at the edge. Alternatively or additionally, the chemical strengthening process may include etching an outer surface of the sharpened substrate to reduce defects and improve fracture strength.

Another aspect of the present disclosure provides a razor blade made with a ceramic material, such as single-crystal alpha-alumina, in which the razor edge of the blade is oriented perpendicular to the c-axis of the crystal structure of the ceramic material for improving strength and resistance breakage at the edge of the blade.

According to an aspect of the present disclosure, a razor blade includes: a substrate made with a ceramic material, the substrate having a razor edge, wherein the razor edge is oriented perpendicularly to a c-axis of a crystal structure of the ceramic material.

According to another aspect of the present disclosure, a razor blade includes: a substrate made with a ceramic material; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion (1) terminating at a razor edge extending along a width of the substrate and (2) formed between the beveled surface and the first substrate surface; wherein the razor edge is oriented perpendicularly to a c-axis of a crystal structure of the ceramic material.

With respect to razor assemblies, such as cartridges or other holders of razor blades, one problem with some conventional designs is that the stainless steel blades may be rigidly fixed in place to prevent flexing of the blade and/or the blades may be mounted to allow rocking about the razor edge. Although these conventional designs may provide a certain degree of perceived comfort while shaving, such features may cause damage to the skin and/or may reduce the useable life of the blade.

An aspect of the present disclosure provides a razor assembly that enhances the life of the razor blade(s) while also providing comfort while shaving with the blade(s).

More particularly, an aspect of the present disclosure provides a razor assembly including a razor blade mounting head for mounting at least one razor blade, in which the mounting head has at least one razor blade receiver that receives and mounts the at least one blade in a manner that restricts rotation of the blade about a pivot axis that is parallel to the blade edge. Such mounting of the blade, particularly for ceramic or glass blades, may improve strength and resistance to breakage at the edge of the blade.

According to an aspect, the mounting head may be configured to enable the blade(s) to move in a direction perpendicular to the blade edge and parallel to the substrate plane for enhancing comfort, and more particularly which may provide some give or play in the movement of the blade that may further enhance the life of the blade, particularly for ceramic or glass blades.

According to an aspect, the mounting head may be configured to mount the blade(s) in a manner that enables each blade to be free to flex or bow along its major substrate plane, with such bow being in a direction along the razor edge.

According to an aspect, a razor assembly includes: a razor blade mounting head having at least one razor blade receiver; and at least one razor blade having a razor edge configured to shave hair; wherein the at least one razor blade is mounted in the at least one razor blade receiver, such that: the at least one razor blade is restricted from rotating about a pivot axis parallel to the razor edge; and the at least one razor blade is permitted to move in an axial direction that is perpendicular to the razor edge. Another problem with some conventional razor assemblies is that the stainless steel blades may be mounted close together at a shallow angle relative to the cutting plane, which can cause shaved hairs to get clogged between the blades.

Another aspect of the present disclosure provides a razor assembly including a razor blade mounting head for mounting a plurality of glass or ceramic razor blades, in which the blades are laterally spaced apart and oriented at a steep angle relative to the cutting plane for enabling improved passage of the shaved hair. The glass or ceramic blades may have a single beveled surface to further enhance the spacing and passage of hair.

According to an aspect, a razor assembly includes: a razor blade mounting head; and a plurality of razor blades mounted in the mounting head, each of the plurality of blades having a beveled surface and a razor edge that is disposed in a cutting plane; wherein the plurality of razor blades are laterally spaced apart from each other to enable passage of hair therebetween; and wherein each of the plurality of blades are oriented in the razor blade mounting head, such that the beveled surface of each of the plurality of razor blades is angled relative to the cutting plane by an angle in the range from five degrees to fifteen degrees.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a perspective view of an exemplary embodiment of a non-metallic razor blade according to the present disclosure.

FIG. 2 is a side view of the razor blade of FIG. 1.

FIG. 3 is an enlarged side view of the razor blade of FIGS. 1 and 2.

FIG. 4 is an enlarged side view of an exemplary chemically strengthened glass razor blade according to an embodiment of the present disclosure.

FIG. 5 is an enlarged side view of an exemplary ceramic razor blade according to an embodiment of the present disclosure.

FIG. 6 shows an exemplary crystal structure of the crystal substrate of the razor blade of FIG. 5.

FIG. 7 is a bottom perspective view of an exemplary razor blade mounting head according to an embodiment of the present disclosure.

FIG. 8 is an enlarged bottom perspective view of the razor blade mounting head of FIG. 7.

FIG. 9 is a top perspective view of the razor blade mounting head of FIG. 7.

FIG. 10 is an enlarged top perspective view of the razor blade mounting head of FIG. 9.

FIG. 11 is a cross-sectional schematic front view of another exemplary razor assembly according to an embodiment of the present disclosure.

FIG. 12 is a cross-sectional schematic top view of the razor assembly of FIG. 11.

FIG. 13 is a schematic view of the razor assembly of FIGS. 11 and 12 interacting with skin and hair while shaving.

### DETAILED DESCRIPTION

Exemplary embodiments according to the present disclosure will now be described in detail with exemplary reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

The principles and aspects of the present disclosure relate to non-metallic razor blades, such as those made with ceramic or glass, and more particularly to one or more unique features of such blades that improve the durability and useable life of the blade.

In addition, the principles and aspects of the present disclosure relate to razor assemblies such as for use with non-metallic blades, which may enhance the life of the razor blades while also improving comfort and usability while shaving.

As will be understood by one of ordinary skill in the art, embodiment(s) according to the present disclosure may include one or more of the principles, aspects and/or features described in each of the below subsections, separately or in any combination with one or more of the principles, aspects and/or features described in any other subsection(s).

Single Bevel Non-Metallic Razor Blade

As discussed above, conventional stainless steel razor blades are relatively ductile and prone to damage, corrosion, and wear. To address such problems associated with conventional stainless steel blades, an aspect of the present disclosure provides a non-metallic razor blade made with ceramic or glass.

Such non-metallic razor blades made with ceramic or glass may have greater hardness and improved corrosion resistance compared to stainless steel, however, such non-metallic materials generally have lower fracture toughness than stainless steel. Accordingly, a glass or ceramic substrate forming the razor blade may be prone to breakage, particularly at the relatively thin area (thickness) forming the blade tip.

According to an aspect of the present disclosure, a razor blade formed of ceramic or glass includes a single-bevel design having a unique geometry of the bevel angle and/or the blade tip to mitigate breakage or other damage thereby enhancing the life of the blade.

In addition, conventional blade designs are not known to accommodate for differences between the shaving needs between males and females and the differences in hair types.

Accordingly, another aspect of the present disclosure provides for different blade geometries depending on the whether the intended use of the design is for a male or female.

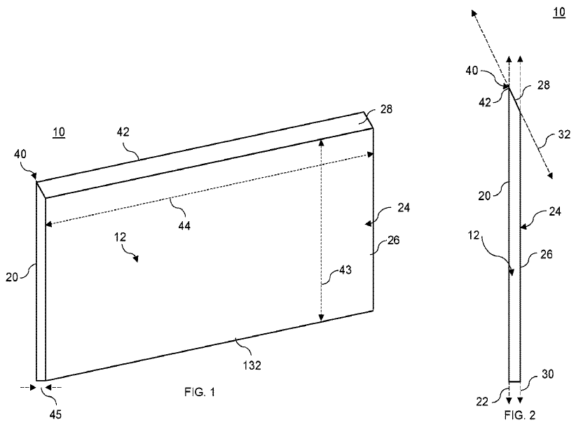

Turning to FIGS. 1-3, an exemplary razor blade 10 including a substrate 12 made with a non-metallic material is shown. In the illustrated embodiment, an entirety of the substrate 12 is made with the non-metallic material. The razor blade 10 has a first substrate surface 20, a second substrate surface 24, and a tip portion 40. The first substrate surface 20 extends along a first substrate plane 22. The second substrate surface 24 is opposite the first substrate surface 20 and includes a primary surface 26 and a beveled surface 28. The tip portion 40 terminates at a razor edge 42 extending along a width 44 of the substrate 12. The tip portion 40 is formed between the beveled surface 28 and the first substrate surface 20.

The substrate 12 of the razor blade 10 may be made by any suitable process, such as being formed or cut from a blank. The substrate 12 may be formed or sharpened to form the beveled surface 28 and razor edge 42 using any suitable technique, e.g., mechanical polishing, chemical polishing, mechanochemical polishing, forced ion beam or laser cutting, micro deposited additive manufacturing, or the like.

As described above, the substrate 12 includes a first substrate surface 20 and a second substrate surface 24. The primary surface 26 of the second substrate surface 24 extends along a second substrate plane 30. As shown, the primary surface 26 may be a flat planar surface which may constitute a majority of the second substrate surface 24. The beveled surface 28 tapers at an angle along a beveled plane 32 from the primary surface 26 of the second substrate surface 24 towards the first substrate surface 20. The tip portion 40 includes a major surface 50 that is proximal the razor edge 42. As shown, the major surface 50 is at least partially disposed in a tip plane 52 that diverges from the beveled plane 32 towards the first substrate surface 20.

As discussed above, the exemplary razor blade 10 has a unique geometry that is configured to mitigate breakage or other damage for enhancing the life of the blade. In exemplary embodiments, the razor blade 10 is configured to have a first included angle 60 between the first substrate plane 20 and the beveled plane 32 that is in a range from about 15 degrees to about 40 degrees. More particularly, the first included angle 60 may be in the range from about 18 degrees to about 30 degrees. In exemplary embodiments, the included angle may be in the range from about 18 degrees to about 25 degrees, or in the range from about 25 degrees to about 30 degrees, depending on the particular application, such as for male or female blades, as discussed in further detail below. In addition, the razor blade 10 is configured to have a second included angle 62 between the first substrate plane 20 and the tip plane 52 that is in a range from about 20 degrees to about 70 degrees. For example, the second included angle 62 may be within a range from about 40 degrees to about 50 degrees, more particularly about 45 degrees.

The non-metallic material of the substrate 12 may comprise a glass material, such as an amorphous glass. The glass material may comprise at least one of: SiO₂, Al₂O3, Na₂O, K₂O, BaO, MgO, CaO, TiO₂, B₂O₃, and ZnO. For example, the non-metallic material may comprise a silicate glass (e.g., having SiO₂); sodium silicate glass (e.g., having SiO₂ and Na₂O); soda lime glass (e.g., having SiO₂, Na₂O, CaO, MgO, Al₂O₃); borosilicate glass (e.g., having SiO₂ and B₂O₃), such as sodium borosilicate glass (e.g., further having Na₂O) or aluminoborosilicate glass (e.g., further having Al₂O₃); or an aluminosilicate glass (e.g., having SiO₂, Al₂O₃, Na₂O, and B₂O₃, and possibly further including CaO, MgO, BaO, TiO₂, and/or ZnO), such as an alkali aluminosilicate glass.

In another example, the non-metallic material of the substrate 12 may comprise a ceramic material. For example, the ceramic material may be a relatively hard ceramic, such as sapphire (e.g., alpha alumina). In exemplary embodiments, the ceramic substrate (e.g., sapphire) may be formed as a single crystal. In exemplary embodiments, the crystal structure of the ceramic substrate 12 (e.g., sapphire) has a c-axis that may be oriented (i) parallel to at least the first substrate plane 20 and (ii) perpendicular to the razor edge 42, as described in further detail below.

The non-metallic substrate 12 (e.g., glass or ceramic substrate) may be formed or processed to have substantially defect-free surfaces. As used herein, a substantially defect-free surface means a surface having a surface roughness on an Ra scale of about 1,000 nanometers or less, such as from about 1 nanometer to about 1,000 nanometers, as measured by light band testing, for example. In exemplary embodiments, the non-metallic substrate 12 may be provided prior to forming the razor edge 42 (e.g., by sharpening) such that at least the first substrate surface 20 and/or second substrate surface 24 are substantially defect-free. Alternatively or additionally, the non-metallic substrate 12 (e.g., glass or ceramic substrate) may be post-processed after forming the razor edge such that the surfaces, including at least the tip portion 40, the razor edge 42, the first substrate surface 20 and/or the second substrate surface 24, are substantially defect-free. Such post-processing may include suitable etching techniques to reduce the size of defects in the surface(s), as described in further detail below. Alternatively or additionally, the substrate 12 may be chemically strengthened before or after forming the razor edge 42, such as via ion-exchange treatment, to thereby enhance the strength of the substrate 12, as described in further detail below.

As shown in FIGS. 1-3, the first substrate surface 20 may be parallel to the primary portion 26 of the second substrate surface 24. As will be understood by one of ordinary skill in the art, the first substrate surface 20 and the second substrate surface 24 being parallel does not require that the substrate surfaces 20, 24 being perfectly parallel to one another. Rather, the substrate surfaces 20, 24 being parallel refers to an angle between the first substrate surface 20 and the second substrate surface 24 being less than about 10 degrees, or more particularly less than about 5 degrees, such as about 1 degree or less.

The substrate 12 may have a generally rectangular configuration as shown in FIG. 1 with a length 43, width 44, and thickness 45. The thickness 45 of the substrate 12 between the first substrate surface 20 and the primary portion 26 of the second substrate surface 24 may be in the range from about 0.3 mm to about 0.6 mm, such as about 0.4 mm. This provides a relatively thick substrate that can help to improve strength and minimize fracture. As will be understood by one of ordinary skill in the art, however, the substrate 12 may have any suitable thickness 45.

A thickness of the tip portion 42 may be less than 1 micrometer (micron). The tip portion 42 may be defined as the portion of the second substrate surface 24 where the beveled surface 28 diverges from the beveled plane 32 towards the tip plane 52.

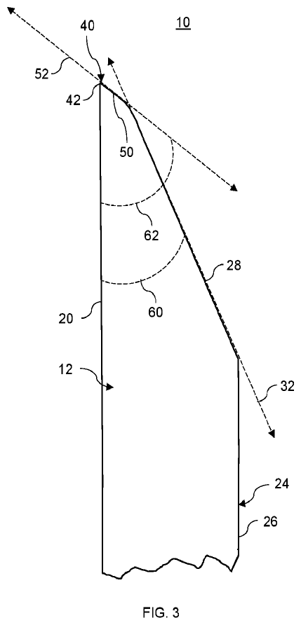

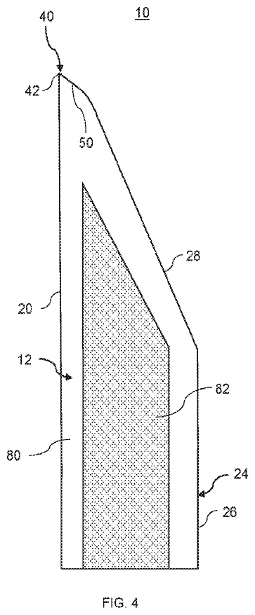

The major surface 50 of the tip portion 40 may be flat (as shown in FIGS. 3 and 4, for example) or the major surface 50 may be continuously curved. For example, a majority (i.e., at least 50%) of the major surface 50 of the tip portion 40 may be flat. The second substrate surface 24 may also include a transition surface 70 located between the bevel surface 50 and the tip portion 40. The transition surface 70 may be curved, such as to blend the major angle and the final radius together while being under 1 micron wide at the start of the transition, for example. Using a curved transition surface 70 reduces sharp edges that could act as crack initiators.

The razor edge 42 forms the sharpest part of the tip portion 40 and enables the blade to shave. Generally, a smaller radius of the razor edge 42 provides a sharper razor blade and a more comfortable shave. In exemplary embodiments, a radius of the razor edge 42 may be in a range from about 50 angstroms to about 500 angstroms, such as from about 100 to about 300 angstroms, more particularly about 200 angstroms, and possibly less than about 50 angstroms.

As shown in FIGS. 1-4, the razor edge 42 may be formed by a single beveled surface. That is, the razor blade 10 may have only a single beveled surface 28. The razor blade 10 having only a single bevel reduces the possibility of defects on both sides of the razor edge 42, increasing thickness and providing a desirable geometry to improve longevity of the razor blade 10.

As discussed above, conventional blade designs are not known to accommodate for differences between the shaving needs of males and females and the differences in hair types. The exemplary razor blade 10 may be configured to be used by males or females by using different blade geometries.

Males generally use razors to shave facial hair, which is a relatively sensitive region of the skin. Moreover, such hairs typically are coarse, and thus require a sharper edge at the possible expense of durability of the blade. Accordingly, in exemplary embodiments a male non-metallic razor blade 10 may have a first included angle in a range from about 18 degrees to about 25 degrees, such as about 20 degrees, or about 18 degrees to about 20 degrees, which increases sharpness while still providing a durable non-metallic blade.

Females, on the other hand, traditionally use razors to shave their legs or armpit hairs. Such hairs are typically less coarse, and these areas are typically less sensitive than for male facial hair. Accordingly, in exemplary embodiments, a female non-metallic razor blade 10 may a have a first included angle in a range from about 25 degrees to about 30 degrees, such as about 27 degrees. The shallower angle enhances the strength while still providing a relatively sharp (e.g., steep) bevel angle, thus balancing increased life at the expense of some perceived comfort, which should be suitable for finer follicles and when used for shaving less sensitive areas, such as legs and the like.

Chemically-Strengthened Glass Razor Blade

Razor blades made of glass may have greater hardness and improved corrosion resistance compared to stainless steel. However, such materials still generally have lower fracture toughness than stainless steels, allowing small defects (such as scratches or cracks) to propagate rapidly and generally unmitigated through the material. Although care may be taken in forming or sharpening the edge of such glass materials, the sharpened surface will inherently include such defects.

According to an aspect of the present disclosure, a razor blade is made with a chemically strengthened glass that is configured to improve strength and resist breakage of the blade, particularly at the razor edge.

Turning to FIG. 4, an exemplary razor blade 10 having a substrate 12 made with a chemically-strengthened glass including a first substrate surface 20 and a second substrate surface 24 is shown. In the illustrated embodiment, an entirety of the substrate 12 is made with glass, and an outer portion of the glass substrate is chemically-strengthened, as discussed in further detail below. The first substrate surface 20 extends along a first substrate plane 22 and the second substrate surface is opposite the first substrate surface 20. In the illustrated embodiment, the second substrate surface 24 includes a primary surface 26 and a beveled surface 28. The primary surface 26 of the second substrate surface 24 extends along a second substrate plane 30. The beveled surface 28 tapers at an angle along a beveled plane 32 from the primary surface 26 of the second substrate surface 24 towards the first substrate surface 20. The razor blade 10 also includes a tip portion (i) terminating at a razor edge extending along a width of the substrate and (ii) formed between the beveled surface and the first substrate surface.

In exemplary embodiments, the chemically-strengthened glass razor blade 10 may have a single beveled surface with the unique geometry for further resisting breakage as described above. It is understood, however, that the chemically-strengthened glass razor blade 10 may include two opposite beveled surfaces or other suitable geometry that forms the razor edge 42.

Compared to the same glass substrate without chemical strengthening, the chemically strengthened substrate 12 may have at least one of a greater hardness or toughness. An entirety of the substrate 12 may be chemically strengthened or only a portion of the substrate 12 may be chemically strengthened. When only a portion is strengthened, the chemically strengthened portion may include an entirety of the tip portion 40, thereby improving strength and resisting breakage of the blade particularly at the tip portion 40 and/or edge 42.

The substrate 12 may be chemically strengthened to a depth below at least one of the first substrate surface 20 or the second substrate surface 24. In exemplary embodiments, the thickness of the substrate 12 is in the range from about 0.3 mm to about 0.6 mm, and the depth of chemical strengthening is in the range from about 2 micrometers (microns) to about 40 microns, more particularly about 10 microns, or possibly less than about 2 microns depending on the thickness of the tip portion, or possibly at least about 40 micrometers (microns) depending on the overall thickness of the blade 10.

The substrate 12 may include a core 80 and an outer layer 82. The outer layer 82 of the substrate 12 may be chemically strengthened and the core 80 of the substrate 12 may not be chemically strengthened. In this manner, the outer layer 82 may have a greater compressive strength than the core 80. Alternatively, an entirety of the substrate 12 may be chemically strengthened (e.g., such that the core and the outer layer have a same compressive strength).

By chemically strengthening to a depth of between about 2 microns to about 40 microns, the entirety of the tip portion 40 (having a thickness of approximately 1 micrometer or less) may be chemically strengthened. In addition, such a relatively thin chemically strengthened layer may be formed with a suitable chemical strengthening technique relatively quickly compared to chemically strengthening the entire substrate 12.

The razor blade 10 also may include a surface coating, such as a lubricant material, for example polytetrafluoroethylene, on at least one of the first substrate surface 20 or the second substrate surface 24.

The glass substrate 12 may comprise any suitable material that is capable of undergoing chemical strengthening. For example, the glass may be an amorphous glass comprising: a soda lime glass (e.g., having SiO₂, Na₂O, CaO, MgO, Al₂O₃); a borosilicate glass (e.g., having SiO₂ and B₂O₃), such as sodium borosilicate glass (e.g., further having Na₂O) or aluminoborosilicate glass (e.g., further having Al₂O₃); or an aluminosilicate glass (e.g., having SiO₂, Al₂O₃, Na₂O, and B₂O₃, and possibly further including CaO, MgO, BaO, TiO₂, and/or ZnO). In exemplary embodiments, the glass substrate 12 comprises an aluminosilicate material. A non-limiting example composition may comprise, in weight percent: 65% SiO₂, 2% Al₂O₃, 7% Na₂O, 7% K₂O, 3% TiO₂, 9% B₂O₃, and 7% ZnO.

The substrate 12 may be strengthened using any suitable chemical process. In exemplary embodiments, the glass substrate 12 may be chemically strengthened (also referred to as chemical tempering) by putting the surface of the glass into compression by an ion exchange technique, in which smaller sized ions in the glass surface are replaced with larger sized ions. During chemical strengthening (e.g., ion exchange), the glass may be submersed in a bath of molten salt at prescribed temperatures. The heat causes the smaller ions to leave the surface of the glass and larger ions present in the molten salts to enter it. Once the glass is removed from the bath and cooled, the glass shrinks, forcing the larger ions present in the surface of the glass to press closer together. This creates a compressed surface, which results in stronger glass that is more resistant to breakage.

As an example, the glass substrate 12 may comprise silicon dioxide, aluminum (e.g., alumina), magnesium (e.g., magnesia), and sodium (e.g., sodium oxide). When the glass is dipped in a hot bath of molten potassium salt, the glass heats up and expands. The heat from the bath increases the migration of the sodium ions out of the glass, allowing potassium ions in the bath to move into the glass and take the place of the departing sodium ions. Because the potassium ions are larger than the sodium ions, the potassium ions get packed into the glass surface more tightly. As the glass cools, the potassium ions are squeezed together, forming a layer of compressive stress on the surface of the glass.

Because the compressive strength of glass is significantly higher than its tensile strength, placing both surfaces of the glass substrate in compression using chemical strengthening alters the glass substrate such that it takes a certain amount of bending before one of the surfaces can even go into tension. Because more bending is required to reach the tensile strength, the other surface simply experiences more and more compressive stress. But, because the compressive strength is so much larger, no compressive failure is experienced.

In exemplary embodiments, the ion-exchange process may be performed such that the outer layer 82 of the substrate 12 has the smaller (e.g., sodium) ions exchanged with the larger (e.g., potassium) ions to provide the chemical strengthening at the layer 82, and the core 80 may maintain the smaller (e.g., sodium) ions so as to be not chemically strengthened. The chemically strengthened ion-exchange layer 82 may be at a depth from about 2 microns to about 40 microns, as discussed above. Although the entirety of the substrate 12 could be chemically strengthened, the relatively thin ion-exchange layer 82 may provide suitable strength, particularly for the tip portion 40 and/or razor edge 42, while also allowing for a relatively quick ion-exchange process.

The chemical strengthening process may be performed prior to forming the beveled surface 28 and/or the razor edge 42 (e.g., providing a chemically-strengthened glass blank and thereafter sharpening) and/or the chemical strengthening process may be performed after forming the beveled surface 28 and/or the razor edge 42 (e.g., after sharpening). For example, a sharpened substrate 12 may be chemically strengthened by performing ion exchange strengthening of an outer surface of the sharpened substrate to increase a strength of a region of the sharpened substrate (e.g., layer 82, and more particularly the tip portion 40). In exemplary embodiments it may be beneficial to perform chemical strengthening after surface treatment (e.g., sharpening and/or polishing), because the surface treatment may decrease the surface compressive stress (e.g., reduce the depth of strengthened glass) and may make the glass substrate 12 weaker. In addition, by chemically strengthening after sharpening, the depth of the chemically strengthened layer may be preserved and/or more uniformly controlled. Furthermore, the chemical strengthening may aid in healing defects in the glass surface caused by the sharpening process. Such chemical strengthening therefore may facilitate providing a substantially defect-free surface.

As noted above, the chemical strengthening process may include any suitable process as would be understood by those having ordinary skill in the art. For example, alternatively or additionally to ion exchange strengthening (discussed above), the chemical strengthening process may include etching one or more outer surfaces of the substrate (e.g. tip portion 40, etc.) to reduce defects and improve fracture strength. The etching process may reduce the size or sharpness of defects such as microscopic scratches or cracks in the glass, and may promote a substantially defect-free surface with a surface roughness on an Ra scale of about 1,000 nanometers or less, such as from about 1 nanometer to about 1,000 nanometers, for example. In exemplary embodiments, such etching may be performed after surface treatment (e.g., sharpening and/or polishing), since the surface treatment may introduce minor scratches in the glass surface, and the etching may reduce or eliminate these scratches. The etching may be performed using any suitable material, such as a suitable acid that erodes the glass, for example, as would be understood by those having ordinary skill in the art.

Ceramic Razor Blade with Improved Strength

Razor blades made of ceramic material, such as sapphire, may typically have greater hardness and improved corrosion resistance compared to stainless steel. Such materials, however, may have lower fracture toughness than stainless steel, particularly depending on the crystallographic orientation of the ceramic material.

According to an aspect of the present disclosure, a razor blade is made with a ceramic material, such as single-crystal alpha-alumina (Al₂O₃), in which the razor edge of the blade is oriented perpendicular to the c-axis of the crystal structure of the ceramic material for improving strength and resistance breakage at the edge of the blade.

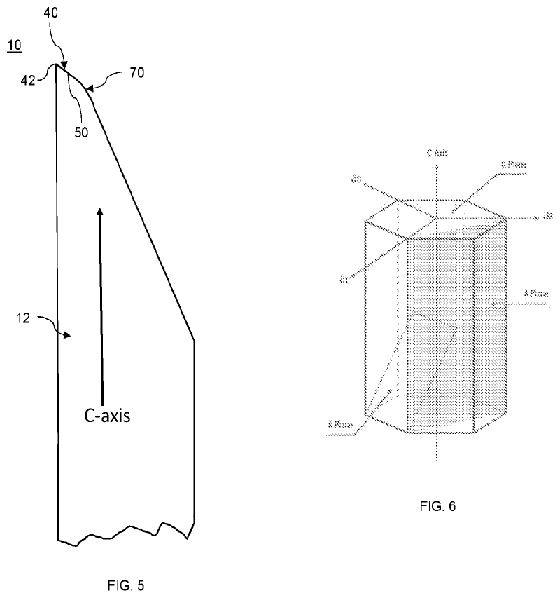

Turning to FIGS. 5 and 6, an exemplary razor blade 10 including a substrate 12 made with a ceramic material is shown. In the illustrated embodiment, an entirety of the substrate 12 is made with the ceramic material. As described above regarding the other embodiments of the razor blade 10, the razor blade 10 includes a first substrate surface 20 extending along a first substrate plane 22. The razor blade 10 also includes a second substrate surface 24 opposite the first substrate surface 22. The second substrate surface 24 includes a primary surface 26 and a beveled surface 28. The primary surface 26 of the second substrate surface 24 extends along a second substrate plane 32. The beveled surface 28 tapers at an angle 60 along a beveled plane 52 from the primary surface 26 of the second substrate surface 24 towards the first substrate surface 20. The razor blade 10 also includes a tip portion 40 that terminates at a razor edge 42 extending along a width 44 of the substrate 12 and which is formed between the beveled surface 28 and the first substrate surface 20.

In exemplary embodiments, the ceramic razor blade 10 may have a single beveled surface with the unique geometry for further resisting breakage as described above. It is understood, however, that the ceramic glass razor blade 10 may include two opposite beveled surfaces or other suitable geometry that forms the razor edge 42.

The ceramic material may be any suitable ceramic material, such as alpha-alumina (i.e., sapphire). In exemplary embodiments, the ceramic material is a single-crystal ceramic, such as single-crystal alpha-alumina material. The ceramic material may be synthetically formed using any suitable process, e.g., the Kyropolis method of forming a boule, the Bagdasarov method (which forms the bulk material in slab form), or the Stepanov method. Following formation of the ceramic into blanks, the ceramic material may be cut and subsequently sharpened to form the razor edge 42 of the razor blade 10.

As shown in FIG. 6, the crystal structure of the ceramic material may comprise a hexagonal system, more particularly of the rhomboidal class, and more particularly rhomboidal class 3 m. For example, the lattice constants of the ceramic material may be a=4.785 and c=12.991 and/or the density of the ceramic material may be about 3.98 g/cc (e.g., 3.95-4.03 g/cc). As shown, the crystal structure includes an A-plane, a C-plane, an R-plane, and a C-axis.

The crystallographic orientation of the ceramic material may have an impact on the fracture characteristics of the ceramic material. In the illustrated embodiment, the razor edge 42 is oriented perpendicularly to a c-axis of a crystal structure of the ceramic material for improving strength and resistance breakage at the edge 42 of the blade. As shown, the c-axis may be parallel to the first substrate plane 22 and/or the second substrate plane 30.

Razor Assembly Having Movable Blades

Many conventional razor assemblies, such as razor blade cartridges or other blade holders, may include a plurality of stainless steel blades that are mounted in the cartridge head in a manner that permits the blades to rock about a pivot axis that is parallel to the blade edge. Such rocking of the blades is believed to provide a more comfortable shave, but this can be at the expense of the longevity of the blade. More particularly, for glass or ceramic blades (which may be more susceptible to fracture based on the configuration and orientation of the blade edge as it shaves hair), such rocking may pivot the edge of the blade to an angle that promotes fracture and/or wear.

According to an aspect of the present disclosure, a razor assembly includes a razor blade mounting head for mounting at least one razor blade, in which the mounting head has at least one razor blade receiver that receives and mounts the at least one blade in a manner that restricts rotation of the blade about a pivot axis that is parallel to the blade edge. Such mounting of the blade, particularly for ceramic or glass blades, may improve strength and resistance to breakage at the edge of the blade.

In exemplary embodiments, the mounting head also is configured to enable the blade to move in a direction perpendicular to the blade edge for enhancing comfort, and more particularly may provide some give or play in the movement of the blade that may further enhance the life of the blade.

In exemplary embodiments, the mounting head also is configured to enable the blade to be free to flex or bow along its major substrate plane, in which such bow is in a direction along the razor edge.

In addition, many conventional razor blade cartridges typically include a plurality of stainless steel blades that may be oriented at a shallow angle relative to the cutting plane to improve comfort during the shave, but which also may cause shaved hairs to clog between the blades. Because glass or ceramic razor blades may be thicker and/or longer than stainless steel blades, the clogging of shaved hair would be exacerbated if the same shallow angle were used.

According to an aspect of the present disclosure, a razor assembly includes a razor blade mounting head for mounting a plurality of glass or ceramic razor blades, in which the blades are laterally spaced apart and oriented at a steep angle relative to the cutting plane for enabling improved passage of the shaved hair. The glass or ceramic blades may have a single beveled surface to further enhance the spacing and passage of hair.

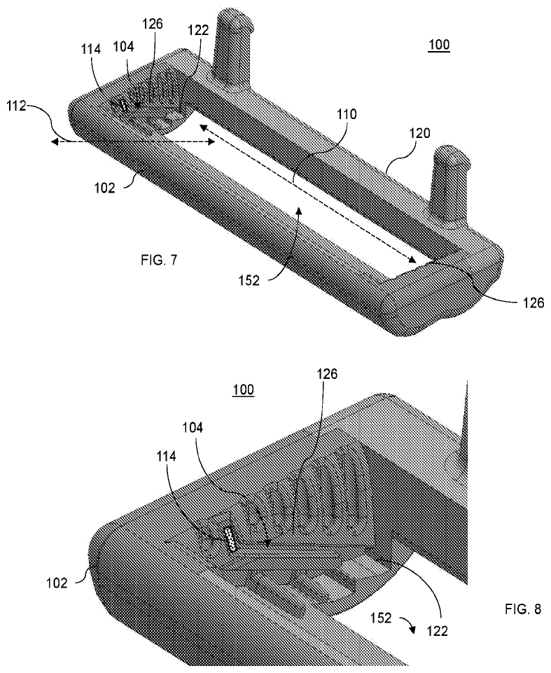

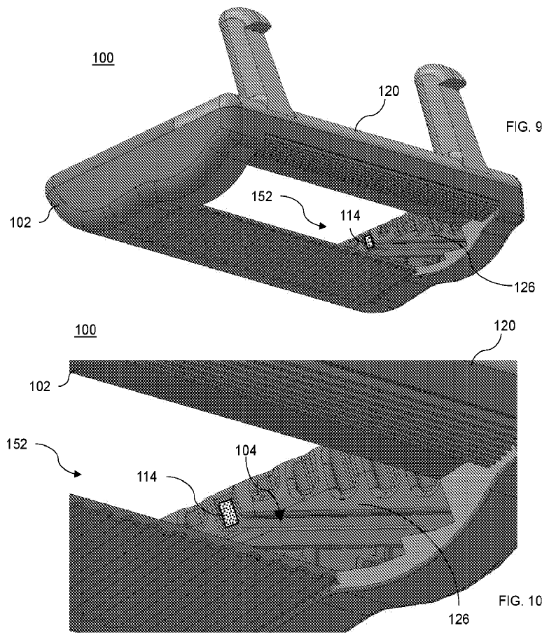

Turning to FIGS. 7-13, exemplary razor assemblies 100 are shown. The razor assembly 100 includes a razor blade mounting head 102 having at least one razor blade receiver 104. The razor assembly 100 also includes at least one razor blade having a razor edge configured to shave hair. As will be understood by one of ordinary skill in the art, the at least one razor blade may comprise any combination of the embodiments of the razor blades 10 described above.

The razor blade mounting head 102 and razor blade receiver 104 may be made with any suitable material. For example, the razor blade mounting head 102 may be made with a combination of rubber, plastic, and/or metal. As shown, the razor blade mounting head 102 may have an opening 152 at a front side 120 thereof for exposing the razor edge 42 of each of the razor blades 10. The opening 152 may be at least partially formed by a forward facing surface 120 of the razor blade mounting head 102 that is configured to engage skin of a user while shaving. In the illustrated embodiment, the razor assembly 100 includes a replaceable cartridge assembly with a removable head 102, however it is understood that the razor blade mounting head 102 may be integral and unitary with other portions of the razor, such as the razor stem.

As discussed above, glass or ceramic blades may be more susceptible to fracture due to rocking of the blades. To obviate or mitigate such effects, the exemplary razor assembly 100 is configured such that the razor blade(s) 10 is mounted in the razor blade receiver(s) 104, such that the razor blade(s) 10 is restricted from rotating about a pivot axis 110 that is parallel to the razor edge 42 (in a direction of the width 44 of the blade). In exemplary embodiments, the razor assembly 100 also is configured to permit the razor blade(s) 10 to move in an axial direction 112 that is perpendicular to the razor edge 42 (parallel to the substrate plane 22 or 30, i.e., in a direction of the length 43 of the blade). As will be understood by one of ordinary skill in the art, the restricted rotation of the razor blade(s) 10 about the pivot axis 110 may permit minor rotation of the razor blade(s) 10 about the pivot axis 110 by about 5 degrees or less, or more particularly by about 1 degree or less. The amount of axial movement permitted by the razor assembly 100 may be in the range from about 0.010 inches to about 0.020 inches, for example.

In exemplary embodiments, the razor blade receiver(s) 104 may each include a biasing member 114 or any other suitable structure that is positioned to operatively engage the razor blade 10 to allow the axial movement. The biasing member 114 may be movable by the razor blade 10 to allow a predefined amount of movement in the axial direction 112 in response to an axial load on the razor edge 42 of the razor blade 10. Alternatively or additionally, the biasing member 114 may apply a biasing force that biases the razor blade(s) 10 towards a front face 120 of the razor blade mounting head 100. For example, the biasing force may be applied forwardly toward a forward stop surface 122 of the razor blade mounting head 102.

In the illustrated embodiment, the biasing member 114 includes a resilient abutment operatively attached to the razor blade mounting head 102, such as being disposed in a surface groove of the head 102. For example, the razor blade receiver(s) 104 may include the resilient abutment positioned to engage a back edge 132 of the razor blade 10 located opposite the razor edge 42. In exemplary embodiments, the abutment is made with a resilient material, such as an elastomeric material, that is compressible to provide a biasing force to the razor blade 10.

In exemplary embodiments, the razor assembly 100 also may be configured to mount the blade(s) 10 in a manner that enables each blade 10 to be free to flex or bow along its major substrate plane 22 or 30 (in a direction of the width 44 of the blade 10). For example, in the illustrated embodiment, the mounting head 102 is configured to hold the blade(s) 10 only along their lateral side portions 130 such that the blade 10 may bow slightly in the width direction 44 when force is applied during shaving. The amount of bow may be in the range from about 0.01 mm to about 0.2 mm, for example. Such freedom to flex or bow may improve the comfort of the shave and provide for less damage to the skin. Because the ceramic or glass blade(s) 10 may have improved strength by virtue of the features described herein, the ceramic or glass blade(s) 10 may withstand such flexure without fracture.

The razor blade receiver(s) 104 may be any suitable receiver(s) for receiving and mounting the razor blade(s) 10 in the mounting head 102. In exemplary embodiments, the razor blade receiver(s) 104 may comprise opposed grooves. A width of each of the opposed grooves may be sized to engage the first and second substrate surfaces 20, 26 of the razor blade 10 to restrict rotation of the razor blade 10 about the pivot axis 110, while also permitting slidable axial movement within the groove. The razor blade receiver(s) 104 may be located on two sides 126 of the razor blade mounting head 102. The two sides 126 may be located opposite one another and lateral to the front face 120. The razor blade receiver 104 may interact with side surfaces 130 of the razor blade 10 to mount the razor blade(s) in the mounting head 102. For example, the razor blade receiver(s) 104 may be configured as resilient snap-in receivers for receiving and mounting the blade(s) 10.

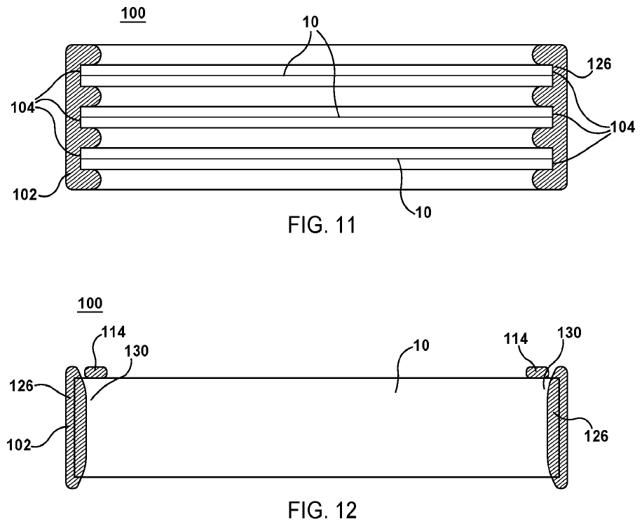

Referring to FIG. 11, the razor assembly 100 may include a plurality of razor blades 10 and a plurality of razor blade receivers 104. Each of the razor blades 10 may be positioned with a particular razor blade receiver 104 of the plurality of razor blade receivers 104. The razor blade receivers 104 may be configured the same as or similar to those described above with reference to FIGS. 7-10. For example, as shown in FIG. 12, each of the plurality of razor blades 10 may abut biasing members 114 (e.g., resilient abutments) to control axial movement of the blades 10. Also as shown in the illustrated embodiment, the razor blades 10 are only mounted along their lateral side portions 130 via receivers 104, which may permit the blades to be free to flex or bow as discussed above.

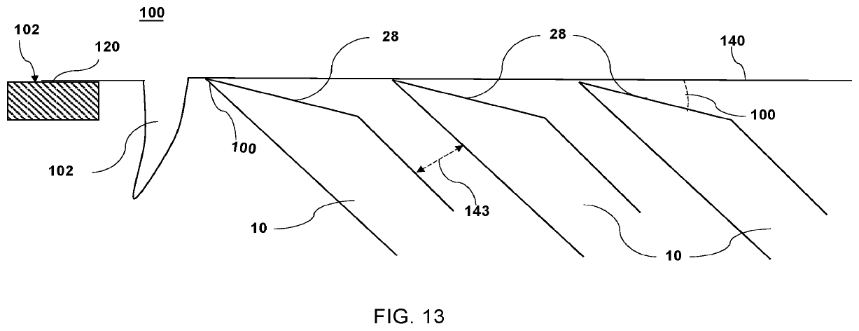

FIG. 13 shows a schematic view of the razor assembly 100 interacting with skin and hair 142 while shaving. The razor assembly 100 includes razor blade mounting head 102 and a plurality of razor blades 10 mounted in the razor blade mounting head 102. Each of the plurality of blades 10 has a beveled surface 28 and a razor edge 42 that is disposed in a cutting plane 140. As shown, the razor blades 10 are laterally spaced 143 apart from each other to enable passage of hair 142 therebetween.

As described above, the razor blades 10 may be made from glass or ceramic and each may have a thickness in a range from about 0.2 mm to about 0.6 mm, more particularly about 0.4 mm. Each of the razor blades 10 may have a leading side 150 of the razor edge 42 and the beveled surface 28 may be opposite the leading side 150.

Because such non-metallic razor blades 10 may be relatively thick and/or long, the exemplary razor assembly 100 configures the blades 10 to be laterally spaced apart and oriented at a steep angle relative to the cutting plane 140 for enabling improved passage of the shaved hair. In exemplary embodiments, the lateral spacing 143 between adjacent razor blade 10 may be in the range from about 0.3 mm to about 0.5 mm. Each of the blades 10 are oriented in the razor blade mounting head 102, such that the beveled surface 28 of each of the razor blades 10 is angled relative to the cutting plane 140 by an angle 144 in the range from five degrees to fifteen degrees. Each of the razor blade(s) 10 may only have a single beveled surface 28 to further enhance the spacing and passage of hair.

The razor blades 10 may be mounted in the razor blade mounting head 102 using only sides 130 of each of the razor blades 10 to further enhance passage of hair 142 between the razor blades 10. That is, the position of the razor blades 10 relative to the razor blade mounting head 102 may be maintained via a connection between the razor blades 10 and the razor blade mounting head 102 only at the sides 130 of the razor blades 10 to minimize the opportunity for cut hair to become trapped between the razor blades 10 at the connection point between the razor blade mounting head 102 and the razor blades 10. As discussed above, the mounting of the razor blades 10 only along the lateral side portions 130 may permit bowing of the blades 10, which may improve comfort of the shave.

Exemplary non-metallic razor blade(s) comprising ceramic or glass have been described herein that include one or more unique aspects that improve the durability and useable life of the blade. In addition, exemplary razor assembl(ies) have been described herein such as for use with such non-metallic blades, which enhance the life of such blades while also improving comfort and usability while shaving.

According to an aspect, a non-metallic razor blade is provided that that improves the durability and useable life of the blade.

According to an aspect, a razor assembly is provided that enhances the life of a razor blade while also improving comfort and usability while shaving.

According to an aspect, a non-metallic razor blade includes: a substrate made with a non-metallic material; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion: terminating at a razor edge extending along a width of the substrate; formed between the beveled surface and the first substrate surface; including a major surface (1) proximal the razor edge and (2) being at least partially disposed in a tip plane that diverges from the beveled plane towards the first substrate surface; wherein a first included angle between the first substrate plane and the beveled plane is in a range from 18 degrees to 30 degrees; and wherein a second included angle between the first substrate plane and the tip plane is in a range from 20 degrees to 70 degrees.

According to an aspect, a razor blade includes a non-metallic material substrate, such as ceramic or glass, the substrate comprising: a first substrate surface extending along a first substrate plane; a second substrate surface opposite the first substrate surface and extending along a second substrate plane; a single beveled surface tapering from the second substrate surface toward the first substrate surface along a bevel plane; a tip portion formed between the beveled surface and the first substrate surface, the tip portion being at least partially disposed in a tip plane that diverges from the bevel plane, the tip portion having a razor edge; wherein a first included angle between the first substrate plane and the beveled plane is in a range from 18 degrees to 30 degrees; and wherein a second included angle between the first substrate plane and the tip plane is in a range from 20 degrees to 70 degrees.

According to an aspect, a method of providing a different blade geometry for males and females may include: providing a blade having one or more of the foregoing features or one or more of the following features, wherein a men's blade has a first included angle in a range from 18 degrees to 25 degrees; and wherein a female's blade has a first included angle in a range from 25 degrees to 30 degrees.

According to an aspect, a razor blade comprises a chemically-strengthened glass substrate having a razor edge.

According to an aspect, a razor blade includes: a substrate made with a chemically-strengthened glass; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion (1) terminating at a razor edge extending along a width of the substrate and (2) formed between the beveled surface and the first substrate surface.

According to an aspect, a method of manufacturing a razor blade includes: providing a glass substrate; sharpening the glass substrate to provide a razor edge; and performing chemical strengthening of the sharpened substrate. The performing chemical strengthening may include performing ion exchange strengthening and/or etching of the sharpened substrate to increase a strength of a region of the sharpened substrate.

According to an aspect, a razor blade includes: a substrate made with a ceramic material, the substrate having a razor edge, wherein the razor edge is oriented perpendicularly to a c-axis of a crystal structure of the ceramic material.

According to an aspect, a razor blade includes: a substrate made with a ceramic material; a first substrate surface extending along a first substrate plane; a second substrate surface opposite the first substrate surface, wherein: the second substrate surface includes a primary surface and a beveled surface; the primary surface of the second substrate surface extends along a second substrate plane; and the beveled surface tapers at an angle along a beveled plane from the primary surface of the second substrate surface towards the first substrate surface; and a tip portion (1) terminating at a razor edge extending along a width of the substrate and (2) formed between the beveled surface and the first substrate surface; wherein the razor edge is oriented perpendicularly to a c-axis of a crystal structure of the ceramic material.

According to an aspect, a razor assembly includes: a razor blade mounting head having at least one razor blade receiver; and at least one razor blade having a razor edge configured to shave hair; wherein the at least one razor blade is mounted in the at least one razor blade receiver, such that: the at least one razor blade is restricted from rotating about a pivot axis parallel to the razor edge; and the at least one razor blade is permitted to move in an axial direction that is perpendicular to the razor edge.

According to an aspect, a razor assembly includes: a razor blade mounting head; and a plurality of razor blades mounted in the mounting head, each of the plurality of blades having a beveled surface and a razor edge that is disposed in a cutting plane; wherein the plurality of razor blades are laterally spaced apart from each other to enable passage of hair therebetween; and wherein each of the plurality of blades are oriented in the razor blade mounting head, such that the beveled surface of each of the plurality of razor blades is angled relative to the cutting plane by an angle in the range from five degrees to fifteen degrees.

Embodiments according to the present disclosure may include one or more of the foregoing aspects, separately or in any combination, which may be combined with one or more of the following additional features, which may be included separately or in any combination.

In some embodiments, the non-metallic material comprises a glass or ceramic.

In some embodiments, the non-metallic material comprises an amorphous glass, such as a soda lime glass, sodium silicate glass, borosilicate glass, sodium borosilicate glass, an aluminosilicate glass, or an alkali aluminosilicate glass.

In some embodiments, the non-metallic material has one or more substantially defect free surfaces, such as a substantially defect free tip portion.

In some embodiments, the non-metallic material comprises glass, the glass having one or more substantially defect free surfaces, such as a substantially defect free tip portion.

In some embodiments, the non-metallic material comprises glass; and the glass is chemically-strengthened.

In some embodiments, the non-metallic material comprises ceramic.

In some embodiments, the ceramic comprises alpha alumina.

In some embodiments, a c-axis of the ceramic substrate is oriented (1) parallel to at least the first substrate plane and (2) perpendicular to the razor edge.

In some embodiments, the first substrate surface is parallel to the primary portion of the second substrate surface.

In some embodiments, a thickness of the substrate between the first substrate surface and the primary portion of the second substrate surface is in the range from 0.3 mm to 0.6 mm, such as 0.4 mm.

In some embodiments, a thickness of the tip portion is less than 1 micrometer (micron).

In some embodiments, the major surface of the tip portion is flat or continuously curved.

In some embodiments, the blade further includes: a transition surface located between the bevel surface and the tip portion; wherein the transition surface is curved.

In some embodiments, a majority of the major surface of the tip portion is flat.

In some embodiments, a radius of the razor edge is in a range from 50 angstroms to 500 angstroms, such as 100 to 300 angstroms, such as 200 angstroms.

In some embodiments, the blade has only a single beveled surface.

In some embodiments, a male non-metallic razor blade has a first included angle in a range from 18 degrees to 25 degrees.

In some embodiments, a female non-metallic razor blade has a first included angle in a range from 25 degrees to 30 degrees.

In some embodiments, the substrate is made with chemically strengthened glass.

In some embodiments, the substrate is made with chemically strengthened glass having at least one of a greater hardness or toughness compared to a same glass substrate without chemical strengthening.

In some embodiments, the chemically strengthened glass is formed via an ion-exchange process.

In some embodiments, the chemically strengthened glass is formed by etching.

In some embodiments, the glass substrate is chemically strengthened to a depth below at least one of the first substrate surface or the second substrate surface.

In some embodiments, the depth is in the range from 2 microns to 40 microns, such as 10 microns.

In some embodiments, a portion of the glass substrate is chemically strengthened and the chemically strengthened portion includes an entirety of the tip portion.

In some embodiments, the glass comprises at least one of: a soda lime glass, sodium silicate glass, borosilicate glass, sodium borosilicate glass, an aluminosilicate glass, or an alkali aluminosilicate glass.

In some embodiments, the glass substrate includes a core and an outer layer; the outer layer of the substrate is chemically strengthened; the core of the substrate is not chemically strengthened; the outer layer has a greater compressive strength than the core.

In some embodiments, an entirety of the glass substrate is chemically strengthened.

In some embodiments, a coating material, such as a lubricant material, for example polytetrafluoroethylene, coating at least one of the first substrate surface or the second substrate surface.

In some embodiments, the substrate is made with a ceramic material, wherein the crystal structure comprises a hexagonal system, more particularly a rhomboidal class.

In some embodiments, the ceramic material is a single-crystal alpha-alumina material.

In some embodiments, the single-crystal alpha-alumina is synthetically formed.

In some embodiments, the lattice constants of the ceramic material are a=4.785 and c=12.991; and/or the density of the ceramic material is 3.98 g/cc.

In some embodiments, the c-axis is parallel to the first substrate plane.

In some embodiments, a razor assembly includes: a razor blade mounting head having a razor blade receiver; and the razor blade having one or more of the foregoing features or one or more of the following features; wherein the at least one razor blade is mounted in the at least one razor blade receiver, such that: the at least one razor blade is restricted from rotating about a pivot axis parallel to the razor edge; and the at least one razor blade is permitted to move in an axial direction that is perpendicular to the razor edge.

In some embodiments, the razor blade receiver includes a biasing member positioned to operatively engage the razor blade to allow the axial movement.

In some embodiments, the biasing member: is movable by the razor blade to allow a predefined amount of movement in the axial direction in response to an axial load on the razor edge of the razor blade; and/or applies a biasing force that biases the razor blade towards a front face of the razor blade mounting head.

In some embodiments, the biasing force is applied forwardly toward a forward stop surface of the razor blade mounting head.

In some embodiments, the biasing member includes a resilient abutment operatively attached to the razor blade mounting head.

In some embodiments, the abutment is made with a resilient material compressible to provide a biasing force to the razor blade.

In some embodiments, the at least one razor blade is mounted in the at least one razor blade receiver such that the razor blade is free to bow in a direction corresponding to the razor edge.

In some embodiments, the at least one razor blade is only mounted on its lateral side portions to permit flexure of the blade.

In some embodiments, the at least one razor blade receiver comprises opposed grooves, a width of each of the opposed grooves sized to restrict rotation of the razor blade about the pivot axis.

In some embodiments, the at least one razor blade receiver is located on two sides of the razor blade mounting head; the two sides are located opposite one another and lateral to the front face; and the razor blade receiver interacts with side surfaces of the razor blade.

In some embodiments, the at least one razor blade receiver includes a resilient abutment positioned to engage a back edge of the razor blade located opposite the razor edge.

In some embodiments, the razor assembly includes a plurality of razor blades and a plurality of razor blade receivers; and each of the plurality of razor blades is positioned with a razor blade receiver of the plurality of razor blade receivers.

In some embodiments, a razor assembly includes: a razor blade mounting head; and a plurality of the razor blades having one or more of the foregoing features or one or more of the following features, mounted in the mounting head, each of the plurality of blades having a beveled surface and a razor edge that is disposed in a cutting plane; wherein the plurality of razor blades are laterally spaced apart from each other to enable passage of hair therebetween; and wherein each of the plurality of blades are oriented in the razor blade mounting head, such that the beveled surface of each of the plurality of razor blades is angled relative to the cutting plane by an angle in the range from 5 degrees to fifteen degrees.

In some embodiments, the lateral spacing is in the range from 0.3 mm to 0.5 mm.

In some embodiments, the plurality of razor blades are made with glass or ceramic and each have a thickness in a range from 0.2 mm to 0.6 mm, such as 0.4 mm.

In some embodiments, each of the plurality of razor blade has only a single beveled surface.

In some embodiments, each of the plurality of razor blades has a leading side of the razor edge and the beveled surface is opposite the leading side.

In some embodiments, the plurality of razor blades are mounted in the mounting head using only sides of each of the plurality of razor blades to enhance passage of hair between the plurality of razor blades.

In some embodiments, the mounting head has an opening at a front side thereof for exposing the razor edge of each of the plurality of razor blades, the opening being at least partially formed by a forward facing surface of the mounting head that is configured to engage skin of a user while shaving.

It is to be understood that terms such as “top,” “bottom,” “upper,” “lower,” “left,” “right,” “front,” “rear,” “forward,” “rearward,” and the like as used herein may refer to an arbitrary frame of reference, rather than to the ordinary gravitational frame of reference.

It is to be understood that all ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1.-48. (canceled)

49. A razor blade comprising:
a substrate made with a chemically-strengthened glass;
a first substrate surface extending along a first substrate plane;
a second substrate surface opposite the first substrate surface, wherein:
the second substrate surface includes a primary surface and a beveled surface;
the primary surface of the second substrate surface extends along a second substrate plane; and
the beveled surface tapers at an angle along a beveled plane from the primary surface of the second substrate surface towards the first substrate surface; and
a tip portion (1) terminating at a razor edge extending along a width of the substrate and (2) formed between the beveled surface and the first substrate surface.

50. The blade of claim 49, wherein:
compared to a same glass substrate without chemical strengthening, the chemically strengthened substrate has at least one of a greater hardness or toughness.

51. The blade of claim 49, wherein the glass is chemically-strengthened via ion exchange treatment and/or etching.

52. The blade of claim 49, wherein:
the substrate is chemically strengthened to a depth below at least one of the first substrate surface or the second substrate surface, more particularly the depth is in the range from 2 micrometers (microns) to 40 microns, more particularly 10 microns.

53. The blade of claim 49, wherein a portion of the substrate is chemically strengthened and the chemically strengthened portion includes an entirety of the tip portion.

54. The blade of claim 49, wherein the chemically-strengthened glass comprises at least one of: soda lime glass, sodium silicate glass, borosilicate glass, sodium borosilicate glass, aluminosilicate glass, or alkali aluminosilicate glass;
more particularly wherein the glass comprises aluminosilicate glass.

55. The blade of claim 49, wherein:
the substrate includes a core and an outer layer;
the outer layer of the substrate is chemically strengthened;
the core of the substrate is not chemically strengthened;
the outer layer has a greater compressive strength than the core.

56. The blade of claim 49, or wherein an entirety of the substrate is chemically strengthened.

57. The blade of claim 49, further comprising a coating material, more particularly a lubricant material, more particularly polytetrafluorethylene, coating at least one of the first substrate surface or the second substrate surface.

58. The blade of claim 49, wherein:
the tip portion includes a major surface (1) proximal the razor edge and (2) being at least partially disposed in a tip plane that diverges from the beveled plane towards the first substrate surface;
a first included angle between the first substrate plane and the beveled plane is in a range from 18 degrees to 30 degrees; and
a second included angle between the first substrate plane and the tip plane is in a range from 20 degrees to 70 degrees.

59. (canceled)

60. The blade of claim 49, wherein the glass has one or more substantially defect free surfaces.

61. (canceled)

62. The blade of claim 61, wherein a thickness of the substrate between the first substrate surface and the primary portion of the second substrate surface is in the range from 0.3 mm to 0.6 mm, more particularly 0.4 mm; and/or
wherein a thickness of the tip portion is less than 1 micrometer (micron).

63.-65. (canceled)

66. The blade of claim 49, wherein a radius of the razor edge is in a range from 50 angstroms to 500 angstroms, more particularly 100 to 300 angstroms, more particularly 200 angstroms.

67. The blade of claim 49, wherein the blade has only a single beveled surface.

68. The blade of claim 49, having a first included angle in a range from 18 degrees to 25 degrees, or having a first included angle in a range from 25 degrees to 30 degrees.

69. (canceled)

70. A method of manufacturing a razor blade comprising:
providing a glass substrate;
sharpening the glass substrate to provide a razor edge; and
performing chemical strengthening of the sharpened substrate.

71. The method according to claim 70, wherein the performing chemical strengthening comprises:
performing ion exchange strengthening of the sharpened substrate to increase a strength of a region of the sharpened substrate; and/or
performing etching of the sharpened substrate.

72.-89. (canceled)

90. A razor blade comprising:
a substrate made with a ceramic material;
a first substrate surface extending along a first substrate plane;
a second substrate surface opposite the first substrate surface, wherein:
the second substrate surface includes a primary surface and a beveled surface;
the primary surface of the second substrate surface extends along a second substrate plane; and
the beveled surface tapers at an angle along a beveled plane from the primary surface of the second substrate surface towards the first substrate surface; and
a tip portion (1) terminating at a razor edge extending along a width of the substrate and (2) formed between the beveled surface and the first substrate surface;
wherein the razor edge is oriented perpendicularly to a c-axis of a crystal structure of the ceramic material.

91. The blade of claim 90, wherein the crystal structure comprises a hexagonal system, more particularly a rhomboidal class.

92. The blade of claim 90, wherein the ceramic material is a single-crystal alpha-alumina material, more particularly that is synthetically formed.

93.-172. (canceled)
